(19) United States
(12) Patent Application Publication
(10) Pub. No.: US 2017/0097738 A1
(43) Pub. Date: Apr. 6, 2017

(54) MOBILE COMMUNICATION DEVICE INTERACTIVE PROJECTION EFFECT SYSTEM

(71) Applicant: Lumo Interactive Inc., Winnipeg (CA)

(72) Inventor: Meghan Jennifer Athavale, Winnipeg (CA)

(21) Appl. No.: 15/311,613

(22) PCT Filed: May 15, 2015
(86) PCT No.: PCT/US2015/031133

§ 371 Date: Nov. 16, 2016

Related U.S. Application Data
(60) Provisional application No. 61/994,402, filed on May 16, 2014.

(51) Int. Cl. G06F 3/042; H04M 1/02; G06T 11/60; H04N 9/31; G09G 3/00; G06F 3/14

(52) U.S. Cl. CPC G06F 3/0425; G09G 3/001; G06F 3/1423; G06T 11/60; H04N 9/3147; H04M 1/0272; G09G 2354/00; H04M 2250/54

(57) ABSTRACT

Various embodiments herein include systems, methods, and software for an mobile entertainment projection device. In addition to projecting entertainment content, the projection device includes a camera for capturing user motion and a graphical display that is arranged to be altered in response to detection of user motion as captured by the camera. Two or more systems may also be used to display a continuous image, such as in projecting streaming video.

### FIELD

Embodiments herein relate to a mobile communication device interactive projection effect and video entertainment system. Some embodiments may include a projector and camera on a single mobile device that projects content, where the content may be adaptive to motion sensed by software in images captured by the camera. Some embodiments may include one or more IR lights or IR cameras. The mobile device may include communication capabilities, such as a cellular voice network, a cellular data network, a local wired or wireless network, or other communication capabilities. Some embodiments may include two or more mobile devices mutually communicating to present a combined projection, such as two or more mobile devices next to each other that double the field of view. Some embodiments include mobile device applications to sense, process, or project interactive video effects. Interactive video applications or additional content may be purchased or obtained through a software portal on the mobile device or on a website. Additional embodiments include content that may be included with other purchased content, such as may be included with the purchase of a music album, eBook, or other electronic media.

### BACKGROUND

Interactive display surfaces are used in various forms for entertainment, promotion, education, and the like. A typical interactive display surface generally comprises a graphical display such as a video screen to display a graphical image or a surface onto which the graphical image may be projected for display to users within an adjacent environment, together with a system for detecting motion of the users within the adjacent environment. The motion detecting system typically relies on a suitable camera directed towards the adjacent environment and a motion-detecting algorithm. The motion-detecting algorithm analyzes the data captured by the camera to determine what type of motion has occurred. The graphical image can then be varied according to various characteristics of the detected motion. For example, an object displayed in the graphical image may be displaced or varied in size, color, or configuration, etc. according to the location or amount of motion detected. The configuration of a graphical display, motion detecting system, and computing device running the motion-detecting algorithm can be quite complex, requiring custom configuration and installation by skilled individuals.

### BRIEF DESCRIPTION OF THE DRAWINGS

FIG. 1 is a block diagram of the general hardware components in an interactive projection effect and entertainment system, according to an embodiment.

FIG. 2 is a block diagram of specific hardware components 200 of an interactive projection effect and entertainment system, according to an embodiment.

FIG. 3 is a block diagram of components involved in installation of an interactive projection effect and entertainment system, according to an embodiment.

FIG. 4 is a representation of positioning and use of an interactive projection effect and entertainment system, according to an embodiment.

FIGS. 5A and 5B are side and front views of a standalone interactive projection effect and entertainment system, according to an embodiment.

FIG. 6 is a representation of a multiple-device projection system 600, according to an embodiment.

In the drawings, like characters of reference indicate corresponding parts in the different figures.

### DETAILED DESCRIPTION

Some embodiments herein include systems, methods, and software for one or more self-contained mobile devices that provide an interactive projection. These mobile devices may allow consumers to project an interactive projection surface on the wall or floor of any room from the mobile devices. These projection systems of such embodiments may be placed or dock-mounted on a horizontal surface such as a floor or table, or otherwise be placed in an environment to project on a horizontal surface, a vertical surface, or both horizontal and vertical surfaces simultaneously or alternatively.

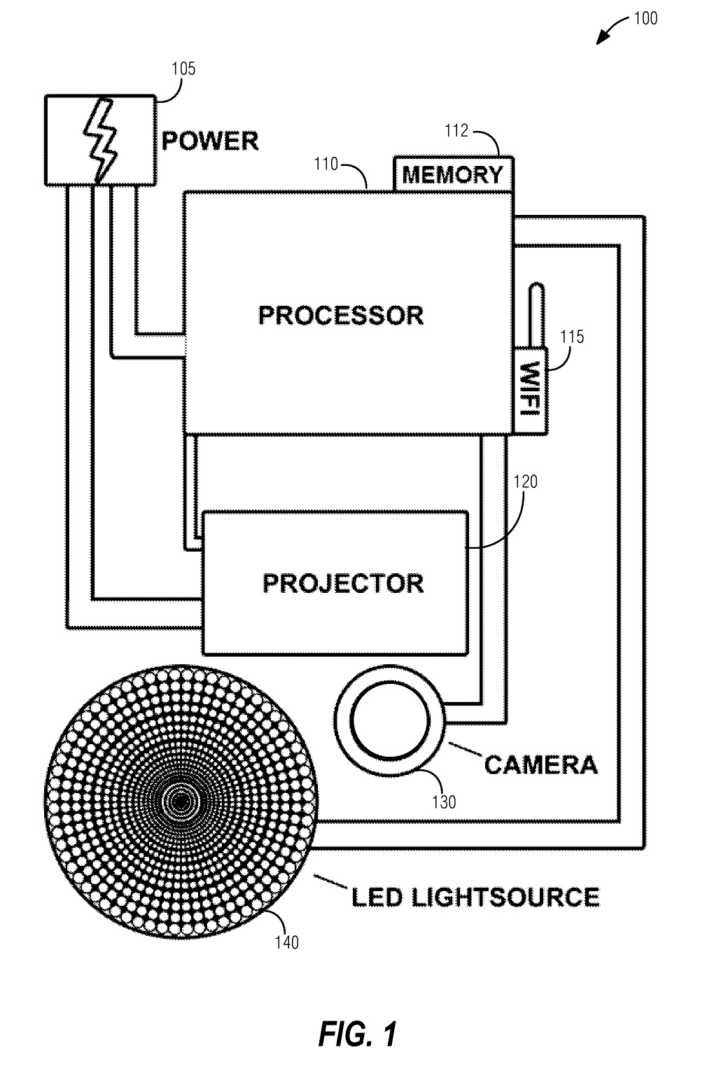

FIG. 1 is a block diagram of general hardware components 100 of an interactive projection effect and entertainment system, according to an embodiment. The hardware components 100 may receive power from an internal or external power source, and may use a power inverter 105. In alternate embodiments, the hardware components 100 may include connectors to connect with and receive power from an electrical outlet, a battery power source, both a batter power source and an electrical outlet, and the like. The hardware components 100 may include a microcomputer processor 110, a projector 120, an image-capturing device 130, and a light source 140.

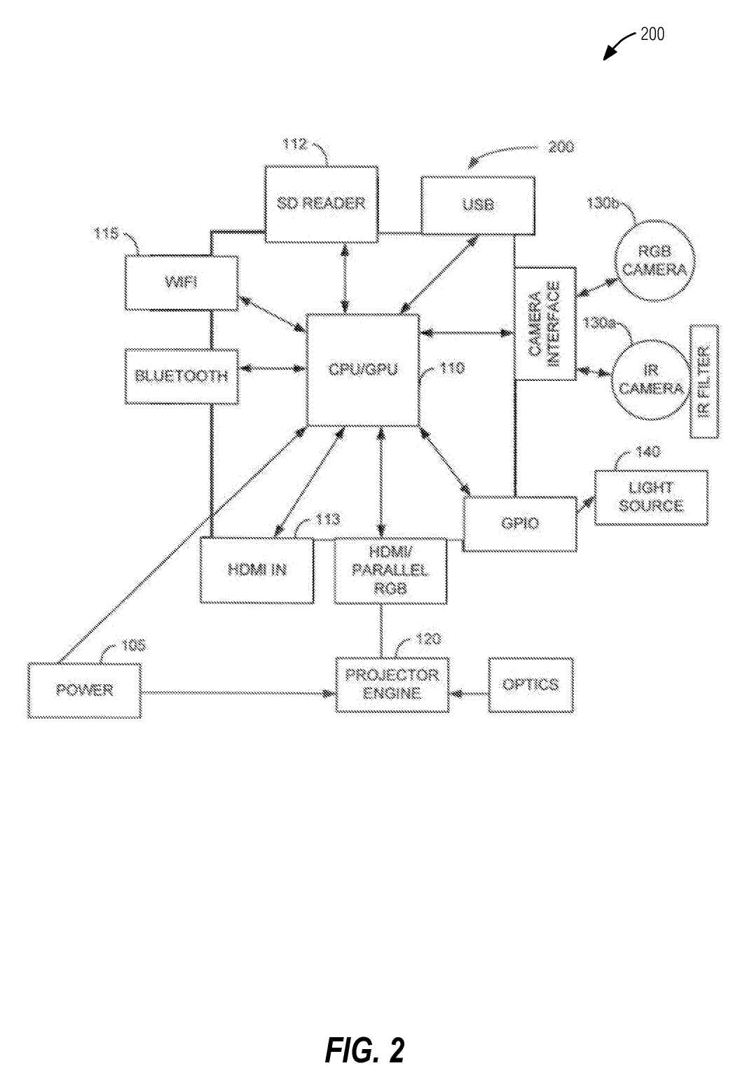

FIG. 2 is a block diagram of specific hardware components 200 of an interactive projection effect and entertainment system, according to an embodiment. The hardware components 100 may use a power inverter 105. The hardware components 100 may include a connector to connect with and receive power from an electrical outlet, a battery power source, both a batter power source and an electrical outlet, and the like. The hardware components 100 include a microcomputer processor 110, a projector 120, an IR image-capturing device 130a, an RGB image-capturing 130b device, and a light source 140.

One or more peripheral or integrated wireless communication devices may be present in some embodiments and be used in conjunction with the hardware components 100. For example, a peripheral Wi-Fi® or Bluetooth® adapter may be connected to the hardware components 100 through an external Universal Serial Bus (USB) port or other communication port. The microcomputer processor 110 may include an integrated wireless communication adapter 115, or a separate wireless communication adapter 115 may be attached directly to the microcomputer processor 110 or to a bus to which the microprocessor is also attached. The wireless communication devices may be used to connect the microcomputer processor 110 to the Internet or other network, or the wireless communication devices may be used as an input device to cause various actions to be executed by the microcomputer processor 110.

The image-capturing device 130 may be in the form of a camera arranged to capture video images of the users in the environment adjacent the output display area to which the graphical display image is displayed. In further instances, the image-capturing device 130 may be arranged to capture video of any moving objects within a target area. In either instance, the video captured comprises a sequence of frames in which each frame is comprised of a two dimensional array of pixels.

The image-capturing device 130a may include a lens that may also have an integrated or attached infrared (IR) filter. The image-capturing device 130a may include an IR light source, an IR light source may be included within the light source 140, or an IR light source may be connected as a peripheral device. The IR light source may project IR light into the target area or surrounding environment adjacent the output display area, for example in a grid pattern. The lens may capture the infrared light reflected back from objects in the target area such that interactive software (e.g., software such as provided by Po-Motion Interactive Software) can use the microcomputer processor 110 to analyze the captured array and define a shape of objects, in either a two-dimensional (2-D) or three-dimensional (3-D) manner, within the target environment by studying how the grid pattern of projected IR light is altered in its reflective state as captured by the lens. The light source may produce ambient or directional IR light of a specific wavelength that will be captured by a lens that is filtered to allow only that wavelength of IR light to be detected by the camera. The lens may be arranged to capture video frames at a predetermined depth of field. The video frames may be comprised of pixels, and the predetermined depth of field may enable the microcomputer processor 110 to interpret each pixel as a distance on a projected interactive display. For example, the following configuration would result in one pixel per inch: the depth of field is selected so that only objects approximately ten feet away are in focus, the interactive display projects a ten foot square projection from a height of ten feet, and the captured image is one hundred and twenty pixels square.

The image-capturing device 130a may include one or more components that enable sensing of 3-D depth, motion, or presence of an object or person. Sensing 3-D depth, motion, or presence may be enabled by augmenting 2-D sensing with a depth sensor to capture motion perpendicular to the image-capturing device 130, such as with sonic or laser range detection. Sensing 3-D depth or motion may also be enabled using stereoscopic vision, such as by using two or more cameras within the image-capturing device 130. Sensing 3-D depth or motion may also be enabled using motion parallax, such as by moving a single camera to capture images from two different angles. Sensing 3-D depth or presence may allow the microcomputer processor 110 to determine when objects are covering a room's floor, such as might be used as a “messy meter” that prevents interactive device operation until the room floor has been cleaned. 3-D depth may also be used to track a child's height or other person's height to determine growth, or may be used to track level of movement to collect health and activity statistics. Sensing 3-D depth, motion, or presence may be used to enable accurate projection of images onto stationary or mobile surfaces, people, toys, or other objects, where the projection of images may be used, for example, to turn a white box into a spaceship, to project colors on people, or to project other interactive and transformative effects. Such modes of depth and motion detection, both 3-D and 2-D, may be used in some embodiments for automated calibration of the hardware components 100 and software that executes thereon.

The light source 140 may include an integrated infrared (IR) light source and an integrated ambient light source, or an integrated infrared (IR) light source or integrated ambient light source may be connected as a peripheral device. The ambient light source may include an LED light source, an incandescent light source, or another ambient light source. The light source 140 may include a dimmer feature for the integrated ambient light source, where the dimmer feature may accept a lower voltage or current and provide a reduced amount of ambient light. The IR light source may include an LED light source or a laser IR light source.

The microcomputer processor 110 may be a standalone processor, or may be a personal computer or laptop having a processor therein to be arranged to execute various algorithms stored on memory 112 in the form of software. Among the algorithms is a motion-detecting algorithm that receives the motion information from the image-capturing device 130 and compares adjacent frames of video in the sequence according to prescribed criteria. The frame comparison may determine where motion occurs within each frame, and may determine how much motion is occurring at any given time. The motion-detecting algorithm may be configured to detect motion for each frame relative to a previous frame in real time as the video is captured. In other embodiments, the motion detection algorithm may be configured to detect motion between every two frames, three frames, or other number of frames as may be desired or set according to a desired resolution of motion detection, as can be satisfactorily processed by available computing resources, and the like. In other embodiments, rather than throttling the motion detection algorithm to scale processing to available computing resources, a frame capture rate of the image capture device may be modified.

The microcomputer processor 110 may include or execute software of an image-generating algorithm that produces an interactive image to be displayed or projected on the output display area. More particularly, the image-generating algorithm may alter a graphical image being displayed in response to the motion detected within the video frames. The microcomputer processor 110 may generate the interactive projection component using interactive software installed on the microcomputer processor 110. The interactive software may receive input camera frames from the image-capturing device 130 and process the input camera frames to generate motion data. Conventional image processing (e.g., computer vision) can be processor-intensive and prone to errors. To improve reliability and processor efficiency, the interactive software may use IR image processing. When the hardware components 100 are in interactive mode, the light source 140 may use the integrated IR light source to wash the projection area with IR light. The IR light is invisible to the naked eye, but the IR light allows the image-capturing device 130a with integrated IR filter, or otherwise with IR sensing capability, to capture motion from users while ignoring other motion activity in the projection area. IR motion data from the image-capturing device 130a may be used by the microcomputer processor 110 to track user position and motion. The motion data may be generated using a shape-detection algorithm. The shape-detection algorithm, in some embodiments, operates on changes from processed frame to processed frame using reflected IR light, and filters out any changes determined to be too small to represent an intentional motion by the user. The shape-detection algorithm provides information about the detected shapes to the interactive software. The interactive software interprets shape changes as motion, where the detected motion is processed to determine if the motion has triggered a “motion event.”

In some embodiments, the microcomputer processor 110 may accept wireless signals from a remote control. The remote control may communicate via infrared (IR), Bluetooth®, Wi-Fi®, or other communication methods. The remote control may be a dedicated remote control, similar to a TV remote, or the remote control may be a computing device running a remote control application, such as a smartphone or tablet device having a remote control app that executes thereon. Using the remote control, a user may turn the interactive projection effect and entertainment system of the hardware components 100 on or off, and may select between an interactive projection and a conventional light. The remote control may also select among available games, streaming internet channels, interactive effects, input sources (i.e., AV, HDMI, TV, digital TV, cable, digital cable, RGB, etc.) similar to switching through channels on a TV. As such, the hardware components 100 may also include one or more additional video inputs to enable connectivity with video sources, such as cable television, over-the-air television signals, set-top boxes, video playing devices, computers, and the like.

In some embodiments, the microcomputer processor 110 may execute interactive content (e.g, entertainment content), such as one or more stored games, streaming media services (e.g., Netflix®, ChromeCast®), or interactive effects. This entertainment content may be installed on the memory 112 associated with the microcomputer processor 110, such as on a hard drive, removeably memory card (e.g., micro SD card, USB drive), random-access memory, other type of memory storage, or streamed from a video source input such as HDMI® 113. The microcomputer processor 110 may also access the entertainment content through an application store. The application store may offer entertainment content for no cost, for a time-limited rental, for purchase, or through other contractual arrangements. The application store may be executed by the microcomputer processor 110, or may be executed on a separate computing device. For example, new entertainment content may be downloaded and managed from a website using a user's phone or laptop, and may be transferred to the memory 112 via a wired connection or wirelessly via the Wi-Fi® adapter 115. In another embodiment, purchased entertainment content may be stored on the internet (e.g., the “cloud”), and can be transferred to the microcomputer processor 110 on an on-demand basis. Although referred to as entertainment content, the entertainment content may instead be educational, informative, instructional, exemplary, and other forms of content.

The microcomputer processor 110 may interact with a graphical user interface displayed on a controller display area. The controller display area may be provided in the form of an auxiliary display separate from the primary display locating the output display area thereon. For example, the graphical user interface may be provided on the remote control, on a smartphone, on a computer, or on another device. The graphical user interface permits interaction with an operator of the system through a user input, where the user input is typically in the form of input controls on a computing device (i.e., keyboard, mouse, touchpad, touchscreen, microphone, video capture device, etc.). The graphical user interface allows the various criteria of the motion-detecting algorithm to be visually represented on the graphical user interface display area such that the user can readily adjust the criteria through the user input. The graphical user interface may also allow the user to adjust the sensitivity of the interactive video system to motion for calibrating the system to the surrounding environment. However, in other embodiments, the user interface may be presented by the hardware components as a projection from the projector 120 with which a user may interact and the user interactions captured by the image-capturing device 130 and motion detecting algorithm. The user interface may include selectable icons and menu items, a projected keyboard, and the like.

The microcomputer processor 110 may include a calibration function to calibrate the interactive projection with the image-capturing device 130. Calibration may correct or compensate for distortion or discontinuity caused by projecting entertainment content onto a surface that is not perpendicular to the projector 120 or image-capturing device 130a or 130b. Once calibrated, the microcomputer processor 110 may correctly process motion on the screen by identifying any area where movement is taking place and converting it to a “touch event,” similar to how screen interactivity is achieved on a touchscreen. Calibration may be accomplished by aligning pattern or motion data from the image-capturing device 130 one or more objects or assets in the projection screen area. Calibration may be performed automatically by using a projected and captured pattern, or may be performed manually through a series of prompted user input events. For example, manual calibration may be accomplished by causing the projector 120 to project one or more calibration points, waiting for the user to touch each calibration point, and using the image-capturing device 130 to record the user motion.

Once calibrated, the microcomputer processor 110 may cause the projector 120 to project an interactive environment. Various interactive environments may include educational environments for home or school. An application may include an interactive play mat for babies, where motion from the projection on the floor stimulates babies and encourages them to move and crawl. An application may include a physically engaging game for one or more children, encouraging children to jump, run, dance, move in order to trigger effects (e.g., make flowers bloom), or win a game (e.g., play soccer, Greedy Greedy Gators, and even interactive versions of well-known, branded games). An application may include a room decoration to help theme an environment (e.g., a front lobby installation). An application may include a resource for children with sensory, motor, or social difficulties, where the interactive responses from the floor may encourage children to explore different types of motion. Other applications may be marketing-oriented, such as an application that causes images of wall colors or pieces of furniture to be projected into an environment to allow a consumer a preview of how the wall color may look or how a piece of furniture may fit or look within the environment, and as may be modified based on color, upholstery, and other options of a piece of furniture. In some embodiments, the calibration functions described above and the 2-D and 3-D motion sensing algorithms may provide data to such a furniture previewing application to facilitate a properly scaled 2-D projection of a piece of furniture to be projected

Various interactive environments may include games for home or school. Motion events in gameplay can be used in various games. A motion event may include a user limb movement that may be interpreted as kicking a ball or hockey puck around to score goals against an opponent. A motion event may include jumping, where the jumping event causes an animation to occur or react in a different way. A motion event may include running, where the running may trigger lighting effects. A motion event may include waving, where the waving may be used to herd or corral animals.

The hardware components 100 may include a motorized mount. The motorized mount may be a moveable mirror configured to redirect the light from the projected interactive environment, or may be a mechanism that reorients the projector 120 or one or more of the other hardware components 100. The motorized mount may be used to select between a wall display of a movie and a floor or wall display of an interactive game. The motorized mount may be used within a video conference to redirect the projector 120 or the image-capturing device 130. The motorized mount may be used to display and interact with the interactive environment using one or many physical objects, such as using a toy to interact with an animated character. The motorized mount may be used to generate a 3-D map of objects, such as by orienting the projector 120 and image-capturing device 130 at furniture, people, or other objects within a room. The motorized mount may also be used to reorient the projected interactive environment to the ceiling, such as for ambience, relaxation, comforting nightlight, or constellation simulations.

The hardware components 100 may also include one or both of one or more speakers and one or more microphones. The speakers may be used to project sound effects, music, web conference or video call audio, or an audio notification such as an alarm. When the user is using a multiplayer interactive environment, the speakers may project sounds from remote players. The microphones may be used to provide voice commands or voice recognition. The speakers and microphones may be used together to provide audio interaction, such as in videoconferencing or audibly interacting with an animated character.

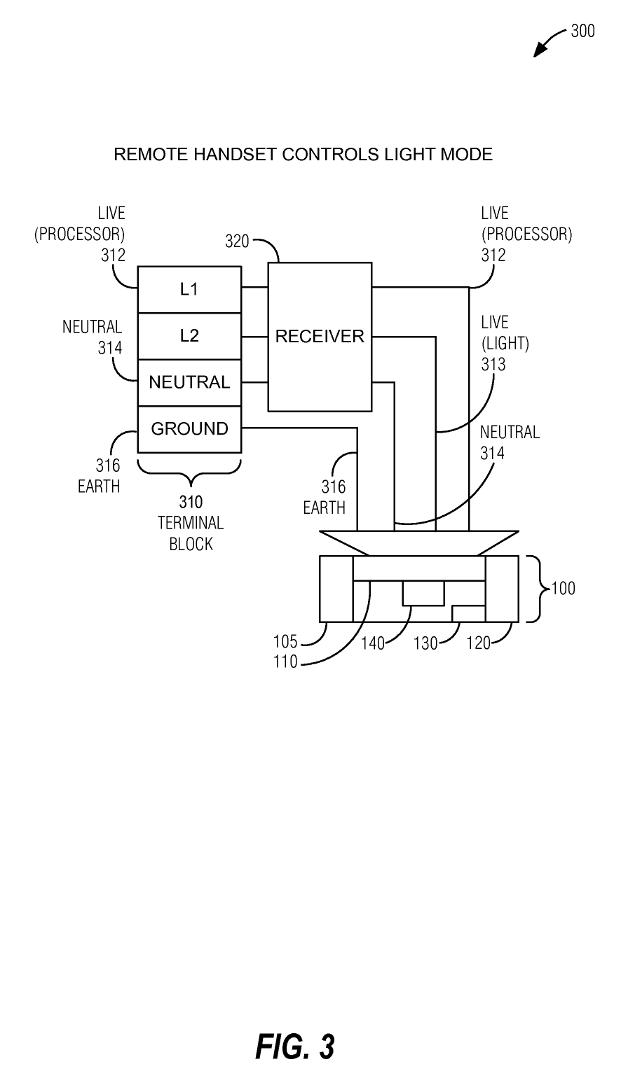

FIG. 3 is a block diagram of installation components 300 of an interactive projection effect and entertainment system, according to an embodiment. In an embodiment, the installation components 300 may be installed on the ceiling of a room, facing down. This installation may be achieved in the same way a standard ceiling light fixture is installed, and may allow a standard ceiling light fixture to be replaced with the installation components 300.

The installation components 300 may include a terminal block 310, a remote control receiver 320, and interactive display hardware components 100. As described above, the hardware components 100 may include a power inverter 105, a microcomputer processor 110, a projector 120, an image-capturing device 130, and a light source 140. The terminal block 310 may include a terminal to connect to one or more live power circuit conductors 312 and 313, a terminal to connect to neutral circuit conductor 314, and a terminal to connect to the earth (e.g., ground) circuit conductor 316. The live processor power terminal 312, the live light power terminal 313, and the neutral terminal 314 are connected to the remote control receiver 320. Using a remote control, the user may cause the remote control receiver 320 to provide power either to the conventional light source 140 or to the microcomputer processor 110, projector 120, and image-capturing device 130. The remote control may be used to cause the remote control receiver 320 to provide a reduced voltage or power to the conventional light source 140 by altering the voltage, thereby dimming the ambient light emitted from the conventional light source 140.

Installation components 300 may be configured to allow a standard ceiling light fixture to be replaced with the installation components 300, though additional installation options may be available. For example, the interactive system may be powered by one or a combination of a hardwired solution, a cord solution, a battery, and a backup battery. A hardwired solution may be configured as described above, or may be wired into an existing light fixture, for example using an Edison style connector. The hardwired solution may also be configured to connect to a home automation system. The home automation system may provide power and various home automation functions, such as closing window blinds when the projector is turned on. The cord solution may plug into a standard North American or other wall outlet, depending on geography of the installation location, and may include an adapter for other wall outlets, voltage levels, or current levels. The battery solution may be rechargeable, and may charge from the household power supply.

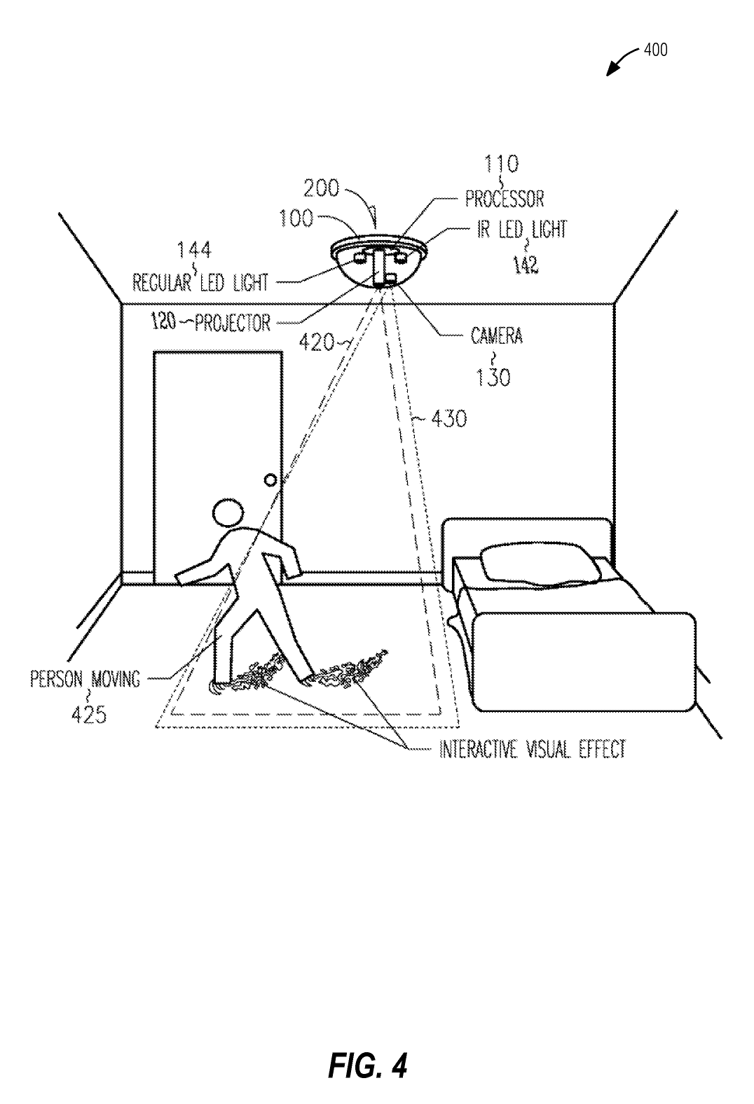

FIG. 4 is a representation of the positioning and functionality 400 of an interactive projection effect and entertainment system, according to an embodiment. In an embodiment, the installation components 300 may be positioned on the ceiling of a room, and may project an interactive image on a floor. In alternate embodiments, the installation components 300 may be included within a mobile device placed on a surface, and may project an interactive image on a wall or ceiling. The installation components 300 may include the hardware components 100, which may include a microcomputer processor 110, a projector 120, an image-capturing device 130, and a light source 140. The light source 140 may include an integrated infrared (IR) light source and an integrated ambient light source, or an independent infrared (IR) light source 142 and an independent ambient light source 144 may be used.

The microcomputer processor 110 may generate the interactive projection component, and may cause the projector 120 to project an interactive scene 420 onto the floor of the room. The user 425 may move within the interactive scene 420, and the image-capturing device 130 may capture the user's movements within the camera field of view 430. The interactive software may receive input camera frames from within the camera field of view 430 and process the input camera frames to generate motion data. The motion data may be used by the interactive software to allow the user to interact with various education or gaming interactive environments.

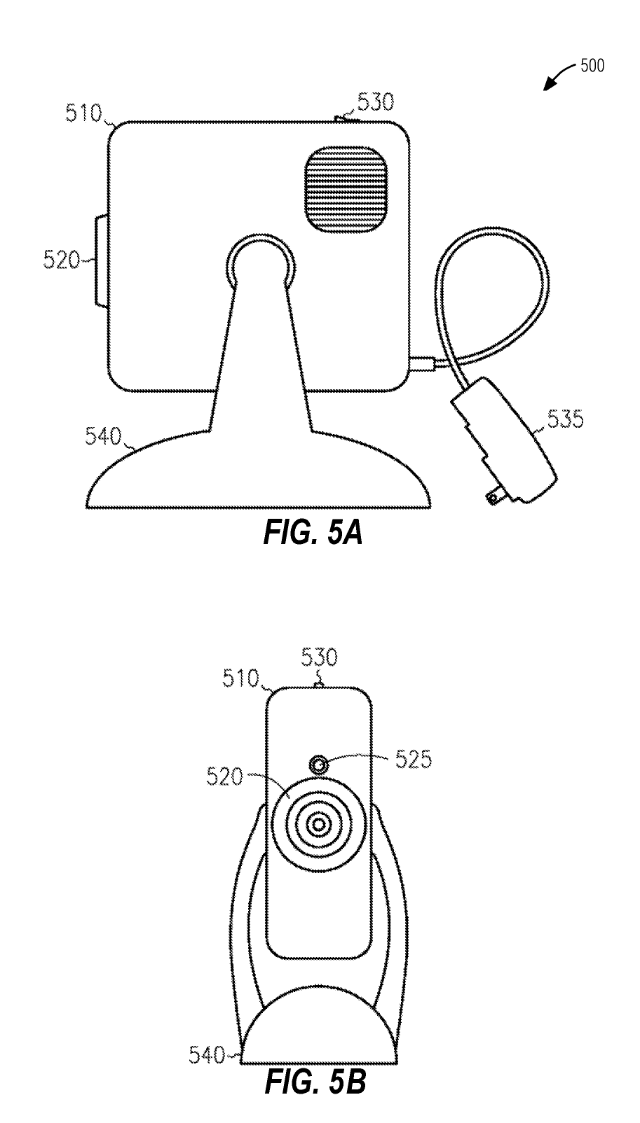

FIGS. 5A and 5B are side and front views of a standalone interactive projection effect and entertainment system 500, according to an embodiment. The standalone system 500 may be used as an alternative to or in addition to a standard ceiling light fixture that includes installation components 300. Though FIGS. 5A and 5B depict a standalone entertainment system 500, the hardware and software within the standalone entertainment system 500 may be included in one or more mobile devices, such as in a mobile cellular phone. The standalone system 500 may include a housing 510 that may include one or more of the hardware components 100. An aperture 520 may be included, and the aperture 520 may allow one or more internal projectors or cameras to project or capture an image. For example, an internal projector may project an interactive scene or a distortion-compensating calibration pattern. The standalone system 500 may be provided without an internal projector, and the aperture 520 may be used by an internal camera to capture image or video. For example, a standalone system 500 may be provided without an internal projector, and may be configured to provide a video output to various external projectors, such as may already be present in a home theatre room of a house or a conference room of a business. The aperture 520 may provide one or more optics distortions or filters. For example, the aperture 520 may include a passive or active IR filter, and the IR filter may reduce light below or above the infrared spectrum. The housing 510 may include one or more additional light emitters or detectors 525, such as an IR emitter/detector. The housing 510 may include one or more buttons, switches, LCD touchscreens, or other hardware controls, such as a power switch 530. To simplify interaction and control of the standalone system 500, the housing 510 may include hardware controls corresponding to buttons on the dedicated or software remote. A power supply 535 may be attached to housing 510, or the device may receive power from an internal, rechargeable power source. The housing 510 may also include one or more connectors, such as audiovisual connectors for external displays or projectors, wired network connectors, USB ports, memory card ports, or other peripheral connectors. The housing 510 may also include one or more internal wireless adapters, such as for Wi-Fi®, Bluetooth®, near-field communication (NFC), IR communication, or other wireless communication.

The standalone system 500 may include a base 540. The base 540 may be mounted on a floor, wall, ceiling, table, or other surface, or the housing 510 may be mounted directly on a surface. The house 510 or base 540 may be secured to a surface using screws, suction cups, or other means. The housing 510 may be attached to the base 540 using screws or other fasteners, or the housing 510 may be removably attached to the base 540 using a quick-attach device or other removable connection. In other embodiments, the base 540 may be weighted to allow the projection effect and entertainment system 500 to be simply set on a horizontal surface, such as a table.

The base 540 may allow the housing 510 to be reoriented vertically or horizontally, and the connection between the base 540 and the housing 510 may hold the housing in a fixed orientation. Orientation of the housing 510 with respect to the base 540, in some embodiments, may be performed manually. However, in other embodiments, orientation of the housing 510 with respect to the base 540 is adjustable by a powered motor. The powered motor may be activated in response to input received via a remote control or via the motion detection algorithms of the projection effect and entertainment system 500.

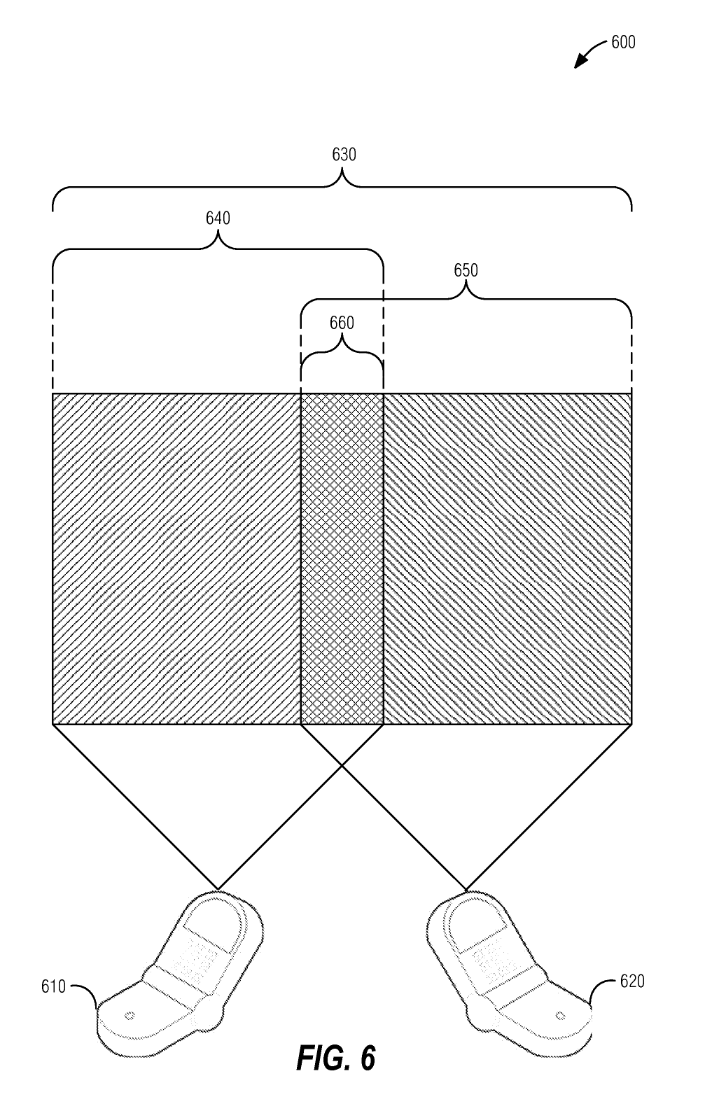

FIG. 6 is a representation of a multiple-device projection system 600, according to an embodiment. The multiple-device projection system 600 may include a first mobile device 610 and a second mobile device 620. Each of the first mobile device 610 and second mobile device 620 may be able to project an interactive image onto a surface, and the two mobile devices 610 and 620 may be used together to project a larger combined image. The first and second mobile devices 610 and 620 may include cellular phones, tablets, laptops, personal data assistants (PDAs), or other mobile devices. The first mobile device 610 may be different from the second mobile device 620.

The mobile devices 610 and 620 may include hardware, software, or interactive content that enables projecting an interactive scene onto a surface. The mobile devices 610 and 620 may access software or interactive content through an application store (e.g., Apple Application store, Google Play store, Amazon Marketplace, etc.). The application store may offer interactive content for no cost, for a time-limited rental, for purchase, or through other contractual arrangements. For example, new interactive content may be downloaded and managed from a website using a user's laptop, and may be transferred to the mobile devices 610 or 620 via a wired connection or wirelessly via Wi-Fi®. In another embodiment, purchased interactive content may be stored on the internet (e.g., the “cloud”), and can be transferred to the mobile devices 610 or 620 on an on-demand basis. Additional embodiments include content that may be included with other purchased content, such as may be included with the purchase of other electric entertainment (e.g., music album, eBook, etc.)

Each mobile device 610 and 620 may include one or more internal projectors or cameras to project or capture an image. For example, an internal projector may project an interactive scene or a distortion-compensating calibration pattern. The mobile devices 610 and 620 may be provided without an internal projector, and the aperture may be used by an internal camera to capture image or video. For example, mobile devices 610 and 620 may be provided without an internal projector, and may be configured to provide a video output to various external projectors, such as may already be present in a home theatre room of a house or a conference room of a business. The mobile devices 610 and 620 may provide one or more optics distortions or filters. For example, the mobile devices 610 and 620 may include a passive or active IR filter, and the IR filter may reduce light below or above the infrared spectrum. The mobile devices 610 and 620 may include one or more additional light emitters or detectors, such as an IR emitter/detector. The mobile devices 610 and 620 may include one or more buttons, switches, LCD touchscreens, or other hardware controls, such as a software user interface or a hardware cellular phone keypad. To simplify interaction and control of the projection system 600, the mobile devices 610 and 620 may include hardware controls corresponding to buttons on the dedicated or software remote. A power supply may be attached to mobile devices 610 and 620, or the device may receive power from an internal, rechargeable power source. The mobile devices 610 and 620 may also include one or more connectors, such as audiovisual connectors for external displays or projectors, wired network connectors, USB ports, memory card ports, or other peripheral connectors. The mobile devices 610 and 620 may also include one or more internal wireless adapters, such as for Wi-Fi®, Bluetooth®, near-field communication (NFC), IR communication, or other wireless communication.

One or more internal sensors may be used to detect orientation or movement of the mobile devices 610 and 620, such as an accelerometer, gyroscope, or other sensor. Detection of orientation may be used for calibration, where calibration allows for correction of a distortion caused by projecting interactive content onto a surface that is not perpendicular to the mobile devices 610 and 620. For example, projecting an image from the floor onto a wall will cause a trapezoidal distortion (e.g., keystone distortion), where the top of the image appears wider than the bottom of the image. The projection system 600 may use the detected orientation to determine the surface onto which the interactive content is being projected and what amount of distortion correction to apply. For example, if the projection system 600 detects an orientation that corresponds to pointing one of the mobile devices 610 and 620 forty-five degrees above the ground, the projection system 600 may determine that the interactive content is being projected onto a nearby wall, and may correct for distortion corresponding to a forty-five degree angle.

Additional distortions may be detected and corrected using various means. For example, a horizontal trapezoidal distortion may occur if the mobile devices 610 and 620 are pointing to the left or right of a line perpendicular with a projection surface. This horizontal distortion may be detected using a combination of orientation and rotation sensors in the mobile devices 610 and 620, and the projection system 600 may calculate the horizontal distortion as a function of the difference between the orientation of the mobile devices 610 and 620. The distortion of the projection may also be corrected using an active feedback loop between the camera and the projection. For example, a camera may capture an image of the projection, compare the captured image to the original interactive content source, and the projection system 600 may detect and correct for any distortion. As another example, an IR emitter may project a distortion-detection pattern (e.g., points, lines, grids, or other patterns) onto the projection surface, such as the lines shown in projection 640 and 650. An IR camera may capture an image of the projected pattern, compare the captured image to the original pattern, and the projection system 600 may detect and correct any distortion.

The distortion mitigation techniques may be applied to edge-blending between the two mobile devices 610 and 620. As shown in FIG. 6, the two mobile devices 610 and 620 may be used to project a contiguous image 630. The distortion mitigation techniques may be used to detect and correct distortion and overlap for the projection from each of the two mobile devices 610 and 620. For example, the interactive content source and an IR distortion-detection pattern may be split vertically and projected by each of the two mobile devices 610 and 620, where mobile device 610 projects image 640 and mobile device 630 projects image 650, resulting in overlapping section 660. A camera may be used to detect and compensate for the overlapping section 660. For example, the overlapping section 660 may be compensated by removing the overlapping section 660 from either projection 640 or 650, the intensity of the overlapping section 660 may be reduced to provide a consistent brightness across projections 640 and 650, or a portion of projections 640 or 650 may be distorted to provide a continuous display. Using this edge-blending technique, projection systems 600 may be configured in a three-by-one widescreen format, a two-by-two enlarged screen format, or any other combination of multiple projection systems 600. The mobile devices 610 and 620 may split a projection and perform this edge-blending technique by communicating between or among the mobile devices 610 and 620, such as by using Wi-Fi®, Bluetooth®, near-field communication (NFC), IR communication, LTE, or other communication methods. The splitting and edge-blending may also occur at the source of the interactive content. For example, mobile devices 610 and 620 streaming video content may provide distortion-detection pattern data to the video streaming provider via the internet, and the video streaming provider may process the data and provide separate video streams that are corrected for distortion and edge-blending. The mobile devices 610 and 620 may also use communication capabilities to exchange status information. For example, if mobile devices 610 and 620 are projecting a combined image and the first mobile device 610 detects that the second mobile device 620 is no longer projecting an image, then the first mobile device 610 may project the entire image. The first mobile device 610 may detect the second mobile device 620 is no longer projecting the image using intra-device communication, by detecting a communication link failure between the devices, or by using an internal image capture component to detect that only the first mobile device 610 is projecting an image.

Since various modifications can be made to the various embodiments as herein above described, and many apparently widely different embodiments of same made within the spirit and scope of the claims without department from such spirit and scope, it is intended that all matter contained in the accompanying specification shall be interpreted as illustrative only and not in a limiting sense.

What is claimed is:

1. A method of providing an interactive display, the method comprising:
emitting an infrared light;
capturing a first infrared image and a second infrared image, the first infrared image being different from the second infrared image;
comparing the first infrared image to the second infrared image, the comparison indicating that a motion event has occurred;
updating a graphical image in response to the motion event; and
projecting, using a mobile device, the graphical image onto a surface.

2. The method of claim 1, further including:
dividing the updated graphical image into a plurality of image divisions; and
projecting, using a plurality of mobile device projectors, the plurality of image divisions onto a surface.

3. The method of claim 2, further including:
detecting an overlap of the plurality of image divisions; and
correcting at least one of the plurality of image divisions to remove the overlap of the plurality of image divisions to generate a plurality of edge-blended images.

4. The method of claim 3, further including communicating the edge-blended images between at least two of the plurality of mobile device projectors.

5. The method of claim 3 wherein detecting the overlap of the plurality of image divisions includes:
capturing a composite image of the plurality of image divisions projected onto the surface; and
comparing the composite image to the updated graphical image.

6. The method of claim 3, wherein detecting the overlap of the plurality of image divisions includes:
projecting an edge-detection pattern onto the surface using a mobile device infrared projector;
capturing a pattern image of the edge-detection pattern projected onto the surface; and
comparing the pattern image to the edge-detection pattern.
